(19) United States
(12) Patent Application Publication
(10) Pub. No.: US 2012/0203548 A1
(43) Pub. Date: Aug. 9, 2012

(54) VECTOR QUANTISATION DEVICE AND VECTOR QUANTISATION METHOD

(75) Inventor: Toshiyuki Morii, Kanagawa (JP)

(73) Assignee: PANASONIC CORPORATION, Osaka (JP)

(21) Appl. No.: 13/502,228

(22) PCT Filed: Oct. 20, 2010
(86) PCT No.: PCT/JP2010/006225

§ 371 Date: Apr. 16, 2012

(30) Foreign Application Priority Data
Oct. 20, 2009 (JP) 2009-241616
May 14, 2010 (JP) 2010-112374

(51) Int. Cl. G10L 19/00

(52) U.S. Cl. 704/230

(57) ABSTRACT

Disclosed is a vector quantisation device which can reduce the computational complexity of an audio codec without reducing the audio quality. A vector quantisation device (112) searches a codebook using code vectors, with which the impulse response of an audibility weighted synthesis filter is convolved and which configure the codebook, and target vectors. A filtering unit (201) applies a filter exhibiting a low pass and/or a high pass characteristic to the impulse response. If the filter has a high pass characteristic, a compaction unit (202) then compacts the degree of the post-filtering impulse response. A convolution unit (203) convolves the post-filtering impulse response with each of the code vectors. If the filter has a low pass characteristic, a search unit (204) thins out elements of the plurality of code vectors with which the impulse response has been convolved, and elements of the target vectors.

### TECHNICAL FIELD

The present invention relates to a vector quantization apparatus and vector quantization method.

### BACKGROUND ART

In mobile communication, compression encoding of speech or image digital information is essential for efficient transmission band utilization. In this regard, there are great expectations for speech codec (coding/decoding) technology that is widely used in mobile phones, and there is an increasing demand for better sound quality from conventional high-efficiency encoding using a high compression rate. Also, since speech communication is used by the public, standardization is essential, and research and development is being actively undertaken by business enterprises worldwide due to the high value of associated intellectual property rights.

In recent years, standardization of a scalable codec having a multilayered structure has been studied by the ITU-T (International Telecommunication Union—Telecommunication Standardization Sector) and MPEG (Moving Picture Experts Group), and a more efficient and higher-quality speech codec has been sought.

A speech encoding technology whose performance has been greatly improved by CELP (Code Excited Linear Prediction), a basic method in which the vocal tract system of speech is modeled and vector quantization is applied, established 20 years ago, is widely used as a standard method of ITU-T standard G. 729 or ETSI standard AMR (Adaptive Multi-Rate), or the like (see Non-Patent Literature 1, for example). Also, with 3GPP2 standard VMR-WB (Variable-Rate Multimode Wideband), a method whereby speech of a Wide Band (0 Hz to 7 kHz) greater than or equal to a telephone band (Narrow Band: 200 Hz to 3.4 kHz) is encoded using CELP has been standardized (see Non-Patent Literature 2, for example).

### CITATION LIST

### Non-Patent Literature

### NPL 1

ITU-T standard G.729

### NPL2

“Source-Controlled-Variable-Rate Multimode Wideband Speech Codec (VMR-WB), Service options 62 and 63 for Spread Spectrum Systems”, 3GPP2 C.S0052-A, April 2005.

### SUMMARY OF INVENTION

### Technical Problem

However, when a wideband digital signal is encoded by means of CELP, the amount of calculation increases in proportion to the increase in sampling rate compared with a conventional telephone band signal. In particular, a CELP adaptive codebook search has not progressed in temis of a reduction in the amount of calculation as compared with a fixed codebook search. For example, adaptive codebook searches (equation 5.16.1-1 and equation 5.16.1-2) shown in the VMR-WB specification (Non-Patent Literature 2) are almost identical to adaptive codebook searches (Chapter 3.7: equation 37 and equation 38) shown in the ITU-T standard G.729 specification (Non-Patent Literature 1) that was standardized before the VMR-WB specification. That is to say, it can be seen that, although VMR-WB is an algorithm that handles nearly twice as many samples as ITU-T standard G.729, it shows almost no technical progress regarding adaptive codebook searches.

Consequently, although speech quality is improved by wideband use, since the amount of calculation necessary for an adaptive codebook search is large, the amount of codec calculation increases, and there is a major problem of a significant increase in the cost of practical realization.

It is an object of the present invention to provide a vector quantization apparatus and vector quantization method that can reduce the amount of calculation of a speech codec without degrading speech quality when encoding a wideband digital signal.

### Solution to Problem

A vector quantization apparatus of the present invention perforins a search of a codebook composed of a plurality of code vectors and obtains a code indicating a code vector for which encoding distortion is minimal, and employs a configuration provided with: a filtering section that inputs an impulse response of a perceptual weighting synthesis filter, and applies a filter having a low-pass characteristic or a high-pass characteristic or both to the impulse response and generates a first signal; a convolution section that convolves the first signal with each of the plurality of code vectors and generates a second signal; and a search section that performs the search using the second signal and a target vector.

A vector quantization method of the present invention performs a search of a codebook composed of a plurality of code vectors and obtains code indicating a code vector for which encoding distortion is minimal, and is provided with: a filtering step of applying a filter having a low-pass characteristic or a high-pass characteristic or both to an impulse response of a perceptual weighting synthesis filter and generating a first signal; a convolution step of convolving the first signal with each of the plurality of code vectors and generating a second signal; and a search step of performing the search using the second signal and a target vector.

### Advantageous Effects of Invention

The present invention can reduce the amount of calculation of a speech codec with almost no degradation of speech quality.

### BRIEF DESCRIPTION OF DRAWINGS

FIG. 1 is a block diagram showing the configuration of a CELP encoding apparatus according to Embodiment 1 of the present invention;

FIG. 2 is a block diagram showing the configuration of a vector quantization apparatus according to Embodiment 1 of the present invention;

FIG. 3 is a block diagram showing the configuration of a search section of a vector quantization apparatus according to Embodiment 1 of the present invention;

FIG. 4 is a drawing showing a frequency characteristic of a band-pass filter according to Embodiment 1 of the present invention;

FIG. 5 is a drawing showing an example of encoding simulation results according to Embodiment 1 of the present invention;

FIG. 6 is a drawing showing an example of encoding simulation results according to Embodiment 1 of the present invention;

FIG. 7 is a block diagram showing the configuration of a vector quantization apparatus according to Embodiment 2 of the present invention;

FIG. 8 is a block diagram showing the configuration of a search section of a vector quantization apparatus according to Embodiment 2 of the present invention;

FIG. 9 is a drawing showing an example of encoding simulation results according to Embodiment 2 of the present invention;

FIG. 10 is a drawing showing an example of listening experiment results according to Embodiment 2 of the present invention (results for each test subject); and

FIG. 11 is a drawing showing an example of listening experiment results according to Embodiment 2 of the present invention (results for each environmental condition).

### DESCRIPTION OF EMBODIMENTS

Now, embodiments of the present invention will be described in detail with reference to the accompanying drawings. In the following embodiments, a CELP encoding apparatus is used as an example of a speech encoding apparatus using a vector quantization apparatus of the present invention as an adaptive codebook quantization apparatus.

### Embodiment 1

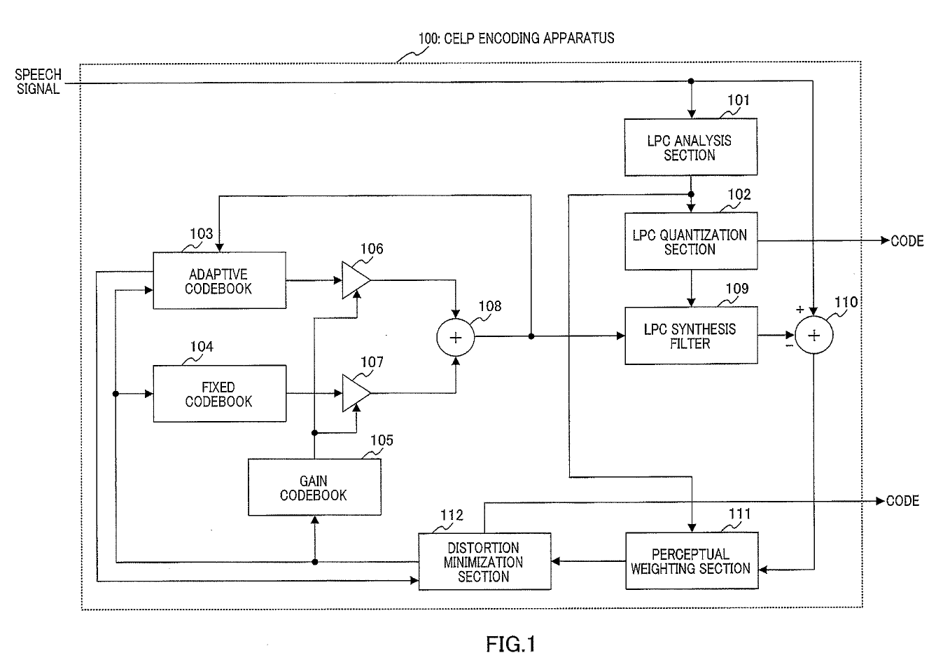

FIG. 1 is a block diagram showing the configuration of CELP encoding apparatus 100 according to this embodiment.

In FIG. 1, for a speech signal comprising vocal tract information and excitation information, CELP encoding apparatus 100 performs encoding by finding an LPC parameter (linear predictive coefficient) for vocal tract information, and performs encoding by finding an index identifying whether one of previously stored speech models is used for excitation information. That is to say, for excitation information, encoding is performed by finding an index (code) identifying what kind of excitation vector (code vector) is generated by adaptive codebook 103 and fixed codebook 104.

Specifically, the sections of CELP encoding apparatus 100 perform the following operations.

LPC analysis section 101 executes linear predictive analysis on a speech signal, finds an LPC parameter that is spectrum envelope information, and outputs the found parameter to LPC quantization section 102 and perceptual weighting section 111.

LPC quantization section 102 quantizes an LPC parameter output from LPC analysis section 101, outputs the obtained quantized LPC parameter to LPC synthesis filter 109, and outputs a quantized LPC parameter index outside CELP encoding apparatus 100.

On the other hand, adaptive codebook 103 stores a past excitation used by LPC synthesis filter 109, and generates a one-subframe excitation vector from the stored excitation in accordance with an adaptive codebook lag corresponding to an index indicated by distortion minimization section 112 described later herein. This excitation vector is output to multiplier 106 as an adaptive codebook vector.

Fixed codebook 104 stores beforehand a plurality of excitation vectors of predetermined shape, and outputs an excitation vector corresponding to the index indicated by distortion minimization section 112 to multiplier 107 as a fixed codebook vector. Here, a case will be described in which fixed codebook 104 is algebraic excitation, and an algebraic codebook is used. Algebraic excitation is excitation adopted by many standard codec.

Above-described adaptive codebook 103 is used to represent a component with strong periodicity, such as voiced sound, while fixed codebook 104 is used to represent a component with weak periodicity, such as white noise.

Gain codebook 105 generates gain for an adaptive codebook vector output from adaptive codebook 103 (adaptive codebook gain) and gain for a fixed codebook vector (fixed codebook gain) output from fixed codebook 104 in accordance with a directive from distortion minimization section 112, and outputs these to multipliers 106 and 107 respectively.

Multiplier 106 multiplies adaptive codebook gain output from gain codebook 105 by adaptive codebook vector output from adaptive codebook 103, and outputs a post-multiplication adaptive codebook vector to adder 108.

Multiplier 107 multiplies fixed codebook gain output from gain codebook 105 by fixed codebook vector output from fixed codebook 104, and outputs a post-multiplication fixed codebook vector to adder 108.

Adder 108 adds an adaptive codebook vector output from multiplier 106 and a fixed codebook vector output from multiplier 107, and outputs a post-addition excitation vector to LPC synthesis filter 109 as excitation.

LPC synthesis filter 109 takes a quantized LPC parameter output from LPC quantization section 102 as a filter coefficient, and generates a synthesized signal using a filter function with an excitation vector generated by adaptive codebook 103 and fixed codebook 104 as excitation—that is, an LPC synthesis filter. This synthesized signal is output to adder 110.

Adder 110 calculates an error signal by subtracting the synthesized signal generated by LPC synthesis filter 109 from the speech signal, and outputs this error signal to perceptual weighting section 111. This error signal corresponds to encoding distortion.

Perceptual weighting section 111 executes perceptual weighting on encoding distortion output from adder 110, and outputs the result to distortion minimization section 112.

Distortion minimization section 112 finds indexes (codes) of adaptive codebook 103, fixed codebook 104 and gain codebook 105 for each subframe such that encoding distortion output from perceptual weighting section 111 becomes minimal, and outputs these indexes outside CELP encoding apparatus 100 as coded information. To be more precise, a synthesized signal is generated based on adaptive codebook 103 and fixed codebook 104 above, a series of processing steps for finding encoding distortion of this signal constitute closed loop control (feedback control), and distortion minimization section 112 searches each codebook by variously changing an index indicated to each codebook within one subframe, and outputs finally obtained indexes of each codebook that minimize encoding distortion.

Excitation when encoding distortion is minimal is fed back to adaptive codebook 103 on a subframe-by-subframe basis. Adaptive codebook 103 updates stored excitation by means of this feedback.

The adaptive codebook 103 search method will now be described. Generally, an adaptive codebook vector and fixed codebook vector are searched for using open loops (separate loops), and an excitation vector search and index (code) derivation are performed by searching for an excitation vector that minimizes encoding distortion in equation 1 below.

E=|x−gHp|² (Equation 1)

E: encoding distortion, x: encoding target (perceptual weighting speech signal), p: adaptive codebook vector, H: perceptual weighting synthesis filter (impulse response matrix), g: adaptive codebook vector ideal gain.

Here, if gain g is assumed to be ideal gain, an equation resulting from partial differentiation of equation 1 above with g becomes 0, and therefore g can be eliminated, and equation 1 above can be transformed into the cost function in equation 2 below. Suffix t represents vector transposition in equation 2.

$$\begin{matrix}( Equation 2 ) & \\ \frac{{x}^{t} Hp}{\sqrt{{p}^{t} {H}^{t} Hp}} & [ 2 ]\end{matrix}$$

That is to say, adaptive codebook vector p that minimizes encoding distortion E in equation 1 above maximizes the cost function in equation 2 above. However, in order to perform limitation to a case in which encoding target x and adaptive codebook vector (synthesized adaptive codebook vector) Hp with which impulse response H is convolved have a positive correlation, the numerator in equation 2 is not squared, and the square root of the denominator is found. That is to say, the numerator in equation 2 represents a correlation value between encoding target x and synthesized adaptive codebook vector Hp, and the denominator in equation 2 represents the square root of the power of synthesized adaptive codebook vector Hp.

Thus, at the time of an adaptive codebook 103 search, CELP encoding apparatus 100 searches for adaptive codebook vector p that maximizes the cost function shown in equation 2, and outputs an index (code) of an adaptive codebook vector that maximizes the cost function outside CELP encoding apparatus 100.

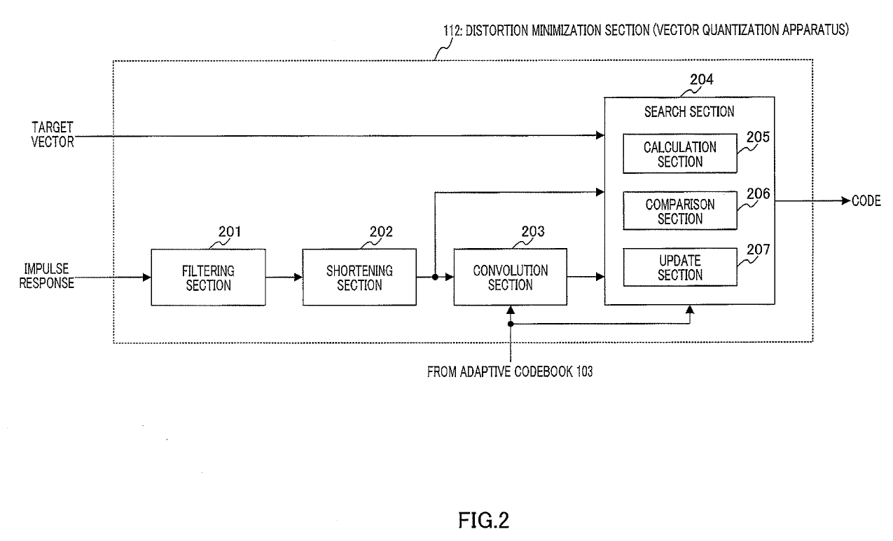

FIG. 2 is a block diagram showing the configuration relating to an adaptive codebook search within the internal configuration of distortion minimization section 112 according to this embodiment. That is to say, FIG. 2 is a block diagram showing an example of distortion minimization section 112 provided with a vector quantization apparatus (adaptive codebook quantization apparatus) according to the present invention as part of its internal configuration.

Encoding distortion (an adaptive codebook search target vector) on which perceptual weighting has been executed by perceptual weighting section 111, and a perceptual weighting section 111 synthesis filter (perceptual weighting synthesis filter) impulse response, are input to the vector quantization apparatus shown in FIG. 2.

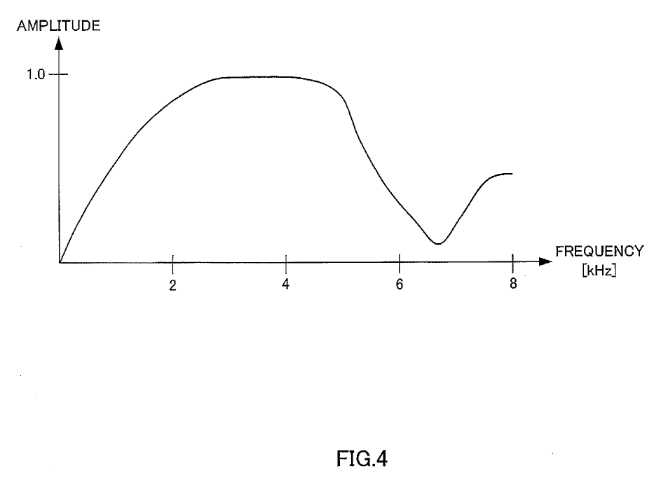

In FIG. 2, filtering section 201 applies a band-pass filter to a perceptual weighting synthesis filter impulse response. Specifically, filtering section 201 convolves an FIR (Finite Impulse Response) filter coefficient with an impulse response. Then filtering section 201 outputs a post-filtering perceptual weighting synthesis filter impulse response (first signal) to shortening section 202. Here, an example of a band-pass filter transfer function used in this embodiment is shown in equation 3, and the frequency characteristic of the transfer function shown in equation 3 is shown in FIG. 4.

(Equation 3)

1+0.35Z⁻¹−0.35Z⁻²−Z⁻³ [3]

It can be seen that in the frequency characteristic shown in FIG. 4 there is a high-pass characteristic from the vicinity of 2 kHz toward 0 Hz. Also, it can be seen that in the frequency characteristic shown in FIG. 4 there is a low-pass characteristic from the vicinity of 4 kHz toward 8 kHz. That is to say, the band-pass filter in filtering section 201 has both a low-pass characteristic and a high-pass characteristic. Since a low-dimensional (4th-order) band-pass filter is used in order to minimize the amount of calculation when applying a band-pass filter to a perceptual weighting synthesis filter impulse response, there is a transmission characteristic from 6 kHz to 8 kHz in the frequency characteristic shown in FIG. 4. However, since components of this frequency band (6 kHz to 8 kHz) are not included to any great extent in a perceptual weighting synthesis filter impulse response, the transmission characteristic does not have a great effect.

Here, with a voiced signal, analysis is possible with periodicity stabilized in the low-frequency domain. Therefore, by having filtering section 201 apply a band-pass filter (equation 3, FIG. 4) to an impulse response, it is possible for down-sampling to be performed with almost no degradation of speech quality due to the low-pass characteristic of the filter. By this means, a correlation value between a target vector and an adaptive codebook vector (synthesized adaptive codebook vector) with which an impulse response has been convolved, and the power of the synthesized adaptive codebook vector, can be found with fewer sums of products. Consequently, the amount of calculation in an adaptive codebook search can be reduced with almost no degradation of speech quality.

Also, a large low-frequency wave is present in a perceptual weighting synthesis filter impulse response, and there is a large low-frequency domain amplitude in high-order components. Thus, by having filtering section 201 apply a band-pass filter (equation 3, FIG. 4) to an impulse response, it is possible to aggregate impulse response components in low-order components by means of the high-pass characteristic of the filter. Thus, by shortening impulse response components into only a low-order part, it is possible to reduce the amount of calculation necessary for convolution of an impulse response and adaptive codebook vector.

Shortening section 202 shortens post-filtering perceptual weighting synthesis filter impulse response components input from filtering section 201 into only a low-order part. For example, the order of an impulse response input from perceptual weighting section 111 is made 64 (0'th to 63rd), the same as the frame order. At this time, shortening section 202 shortens an impulse response input from filtering section 201 into only 24 orders from 0'th to 23rd. In the following description, an impulse response shortened into only a low-order part is referred to as an “improved impulse response (or shortened signal)”. Then shortening section 202 outputs an improved impulse response (shortened signal) to convolution section 203 and search section 204.

Convolution section 203 convolves an improved impulse response (shortened signal) input from shortening section 202 with respect to an entire adaptive codebook vector (adaptive codebook code vector) input from adaptive codebook 103 in accordance with equation 4 below.

(Equation 4)

y₀(n)=Σᵢ₌₀^{24 or n}u(Tₛₜₐᵣₜ+i)·H(n−i) n=0, . . . ,63 [4]

y₀(n): Synthesized initial adaptive codebook vector

u(Tₛₜₐᵣₜ+i): Adaptive codebook vector (adaptive codebook code vector)

Tₛₜₐᵣₜ: Lag (pitch delay) used initially as code vector

H(n−i): Improved impulse response

Then convolution section 203 outputs the obtained synthesized initial adaptive codebook vector yₒ(n) (second signal) to search section 204.

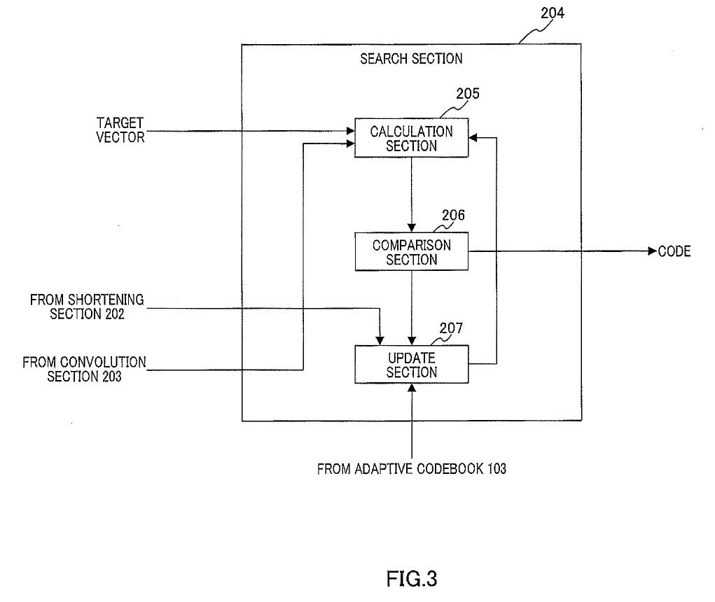

Various adaptive codebook vectors are input to search section 204 from adaptive codebook 103. FIG. 3 is a block diagram showing an example of the internal configuration of search section 204 in FIG. 2. Search section 204 comprises three configuration sections—calculation section 205, comparison section 206, and update section 207—and performs adaptive codebook vector quantization (encoding) by means of three processes in these configuration sections.

Calculation section 205 of search section 204 calculates cost function Eₖ (k: adaptive codebook vector number) shown in equation 5 below using a synthesized adaptive codebook vector (second signal) input from convolution section 203 and a target vector input from perceptual weighting section 111. However, in order to perform limitation to a case in which a target vector and synthesized adaptive codebook vector have a positive correlation, the numerator in equation 5 is not squared, and the square root of the denominator is found. That is to say, the numerator in equation 5 represents a correlation value between target vector x and synthesized adaptive codebook vector yₖ, and the denominator in equation 5 represents the square root of the power of synthesized adaptive codebook vector yₖ.

$$\begin{matrix}( Equation 5 ) & \\ {E}_{k} = \frac{{\sum }_{n = 0}^{31} x ( 2 n ) \cdot {y}_{k} ( 2 n )}{\sqrt{{\sum }_{n = 0}^{31} {y}_{k} ( 2 n ) \cdot {y}_{k} ( 2 n )}} & [ 5 ]\end{matrix}$$

x(2n): Target vector

yₖ(2n): Synthesized adaptive codebook vector

Here, synthesized adaptive codebook vector yₖ(2n) has been synthesized by means of an improved impulse response, and therefore the number of sums of products can be punctured in equation 5. That is to say, as shown in equation 5, calculation section 205 punctures adaptive codebook vector (code vector) yₖ elements and target vector x elements in calculating a cost function. In this embodiment, a sum of products is found every other sample (that is, 2n (n=0, 1, . . . , 31)). That is to say, the number of sums of products is ½ that when a sum of products is found for each sample (n=0, 1, . . . , 63), that is, when sum of products puncturing is not performed (that is, the puncture rate is ½). Comparing this with equation 5.16.1-1 of function Tₖ given in the VMR-WB specification (Non-Patent Literature 2), it is clear that the objects of cost function Eₖ sum of products calculation according to the present invention (n=0 to 31 only) have been reduced.

Comparison section 206 of search section 204 compares cost functions Eₖ calculated successively by calculation section 205, and saves the largest value Eₖ among the calculated cost functions, and its coefficient k. Then, as a result of the adaptive codebook search, comparison section 206 takes coefficient k of the largest cost function Eₖ as optimal adaptive codebook vector number k.

Update section 207 of search section 204 updates synthesized adaptive codebook vector yₖ(n) in accordance with equations 6 below. That is to say, as shown in equations 6, update section 207 updates synthesized adaptive codebook vector yₖ(n) by calculating only difference u(−k)H(n) from synthesized adaptive codebook vector yₖ₋₁(n−1) having the preceding number (k−1). In this embodiment, since improved impulse response H shortened from 64th-order to 24th-order is used, sum of products calculations are performed for only n=0 to 23 as shown in equations 6. Comparing this with equation 5.16.1-2 given in the VMR-WB specification (Non-Patent Literature 2), it is clear that the objects of sum of products calculation (n=0 to 23 only) have been reduced in equations 6 of the present invention.

(Equations 6)

yₖ(n)=yₖ₋₁(n−1)+u(−k)H(n) n=0, . . . ,23

yₖ(n)=yₖ₋₁(n−1) n=24, . . . ,63 [6]

In the above-described way, search section 204 finds and outputs an index (code—that is, optimal adaptive codebook vector number k).

Encoding simulation results indicating the effect of the present invention are shown in FIG. 5. FIG. 5 shows an average value of 16 items of speech data to which various kinds of environmental noise have been added. The original (conventional-method) codec shown in FIG. 5 is an ITU-T standard G. 718 compliant floating-point simulator, with a bit rate of 12 kbps. The amount of calculation (WMOPS: Weighted Mega Operation Per Second) shown in FIG. 5 is an aggregate of operations of only a part relating to an adaptive codebook search.

As shown in FIG. 5, when an encoding apparatus according to the present invention is used, as compared with a case in which an original encoding apparatus is used there is no degradation of speech quality (S/N ratio) (but actually a slight improvement), while the amount of calculation is greatly reduced, by approximately ⅓. That is to say, it has been verified that the amount of calculation in an adaptive codebook search can be greatly reduced, without degrading speech quality, by applying filtering to an impulse response and shortening the impulse response order (using an improved impulse response), and puncturing cost function sum of products calculations in an adaptive codebook search.

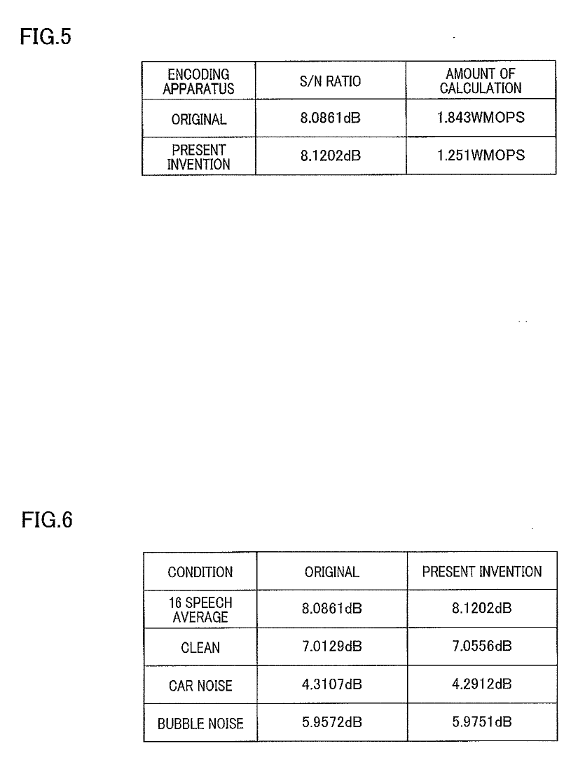

Also, results of an encoding simulation for verifying that speech quality degradation does not occur due to speech environmental conditions are shown in FIG. 6. As in the case of FIG. 5, the original (conventional-method) codec shown in FIG. 6 is an ITU-T standard G.718 compliant floating-point simulator, with a bit rate of 12 kbps. Environmental conditions used in FIG. 6 are an average value of 16 items of speech data to which various kinds of environmental noise have been added, as in the case of FIG. 5, (Condition: 16 speech average), noise-free speech data (Condition: Clean), speech data to which the noise of a moving vehicle has been added (Condition: Car noise), and speech data to which bubble noise (colored noise) has been added (Condition: Bubble noise).

As shown in FIG. 6, with (Condition: Car noise), when an encoding apparatus of the present invention is used, as compared with a case in which an original encoding apparatus is used there is a slight drop in speech quality (S/N ratio), but almost no overall degradation of speech quality. That is to say, there is no degradation of speech quality under any of the environmental conditions, and the robustness of the present invention has been verified.

As described above, according to this embodiment, through the ability to analyze periodicity stabilized in the low-frequency domain with a voiced signal, by applying a filter having a low-pass characteristic to an impulse response, it is possible for down-sampling to be performed with almost no degradation of speech quality due to the low-pass characteristic of the filter. By this means, the amount of calculation necessary for sum of products calculations in a codebook search can be reduced. Also, a perceptual weighting synthesis filter impulse response has large amplitude up to a high-order component due to a large low-frequency wave. As a result, by applying a filter having a high-pass characteristic to an impulse response, impulse response components can be aggregated in low-order components by means of the high-pass characteristic, and an impulse response can be shortened into only a low-order part. By this means, it is possible to reduce the amount of calculation necessary for convolution of an impulse response and adaptive codebook vector. That is to say, it is possible to greatly reduce the amount of speech codec calculation by means of the above two reductions in the amount of calculation.

Specifically, according to this embodiment, a filter having a low-pass characteristic and high-pass characteristic is convolved with respect to a perceptual weighting synthesis filter impulse response. By this means, with a CELP encoding apparatus, objects for which a sum of products is found in cost function (equation 5) sum of products calculation can be punctured by performing down-sampling due to the filter low-pass characteristic, enabling the amount of calculation in an adaptive codebook search to be reduced. Furthermore, with a CELP encoding apparatus, objects for which a sum of products is found when calculating a synthesized adaptive codebook vector (equations 6) can be reduced by shortening an impulse response order by means of the filter high-pass characteristic, enabling the amount of calculation in an adaptive codebook search to be reduced. Thus, according to this embodiment, even when a wideband digital signal is encoded using CELP, the amount of speech codec calculation can be reduced without degrading speech quality.

In this embodiment, a case has been described in which the frame order is 64, the impulse response shortening number (post-shortening order) is 24, and the sum of products calculation puncture rate is ½. However, these figures are only examples, and the present invention can also be applied to any other kinds of specifications.

In this embodiment, a case has been described in which a band-pass filter having a low-pass characteristic and high-pass characteristic is used, but a low-pass filter and high-pass filter may be used in combination instead of a band-pass filter. Also, in this embodiment, a case has been described in which a filter having both a low-pass characteristic and a high-pass characteristic is used, but a filter having either a low-pass characteristic or a high-pass characteristic may also be used. That is to say, if the filter of filtering section 201 shown in FIG. 2 has a high-pass characteristic, shortening section 202 need only shorten the post-filtering impulse response order. Similarly, if the filter of filtering section 201 shown in FIG. 2 has a low-pass characteristic, search section 204 (calculation section 205) can perform an adaptive codebook search after puncturing adaptive codebook vector elements and target vector elements in cost function (equation 5). Furthermore, in this embodiment, the band-pass filter order has been assumed to be 4 as shown in equation 3, but the present invention is not limited to this, and another band-pass filter order may also be used.

A case has been described in which the numerator of the cost function shown in equation 5 in calculation section 205 of search section 204 is a correlation value, and the denominator is a square root of power. However, in the present invention, the numerator of a cost function may be made the square of a correlation value, and the denominator may be made power. Furthermore, to give an advantage to a case in which there is a positive correlation, the square of a correlation value can be multiplied by the polarity (+/−) of the correlation value in a cost function. In this case, a square root is not found by the cost function, enabling the amount of calculation to be further reduced.

In this embodiment, a case has been described in which the present invention is applied to adaptive codebook quantization (encoding). However, the present invention is not limited to an adaptive codebook, and can also be applied to a fixed codebook, for example. Also, with regard to the use of a filter having a low-pass characteristic (in this embodiment, a band-pass filter having the characteristic shown in FIG. 4), and the cost function calculation method used by calculation section 205 of search section 204 (an algorithm that punctures sum of products calculations), an open-loop pitch search performed as prior processing in limitation of the adaptive codebook search pitch in CELP can be used.

### Embodiment 2

First, a search method for adaptive codebook 103 of CELP encoding apparatus 100 (FIG. 1) according to this embodiment will be described. As in Embodiment 1, an adaptive codebook vector and fixed codebook vector are searched for using open loops (separate loops), and an excitation vector search and index (code) derivation are performed by searching for an excitation vector that minimizes encoding distortion in equation 1.

If gain g is assumed to be ideal gain in equation 1, an equation resulting from partial differentiation of equation 1 with g becomes 0, and therefore g can be eliminated, and equation 1 can be transformed into the cost function in equation 2 below. That is to say, adaptive codebook vector p that minimizes encoding distortion E in equation 1 maximizes the cost function in equation 2.

Here, in Embodiment 1, in order to perform limitation to a case in which encoding target x and adaptive codebook vector (synthesized adaptive codebook vector) Hp with which impulse response H is convolved have a positive correlation, the numerator in equation 2 is not squared, and the square root of the denominator is found.

In contrast, in this embodiment, the kind of square root calculation in equation 2 is not performed, as shown in equation 7 below. Specifically, in the numerator of the cost function shown in equation 7, adaptive codebook vector (synthesized vector) Mp with which search convolutional vector M found using a perceptual weighting synthesis filter impulse response is convolved is calculated. Then the numerator of the cost function shown in equation 7 is obtained by multiplying correlation value xtMp, resulting from multiplying synthesized vector Mp by encoding target x, by absolute value |xtMp| of that correlation value. Also, the denominator of the cost function shown in equation 7 is obtained by calculating power ptMtMp of synthesized vector Mp.

$$\begin{matrix}( Equation 7 ) & \\ \frac{{x}^{t} Mp \cdot \vert {x}^{t} Mp \vert}{{p}^{t} {M}^{t} Mp} & [ 7 ]\end{matrix}$$

M: Search convolutional vector convolutional matrix

By means of the cost function calculation shown in equation 7, calculation of the special function “square root” as in the case of the cost function shown in equation 2 is eliminated, and limitation to a case in which encoding target x and synthesized vector Mp have a positive correlation is possible.

Then, at the time of a adaptive codebook 103 search, CELP encoding apparatus 100 searches for adaptive codebook vector p that maximizes the cost function shown in equation 7, and outputs an index (code) of an adaptive codebook vector that maximizes the cost function outside CELP encoding apparatus 100.

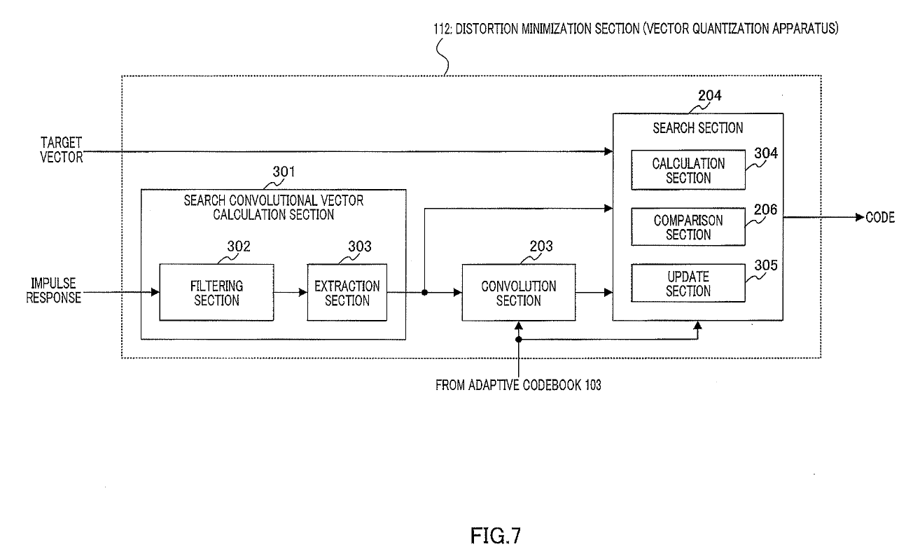

FIG. 7 is a block diagram showing the configuration relating to an adaptive codebook search within the internal configuration of distortion minimization section 112 of CELP encoding apparatus 100 (FIG. 1) according to this embodiment. That is to say, FIG. 7 is a block diagram showing an example of distortion minimization section 112 provided with a vector quantization apparatus (adaptive codebook quantization apparatus) according to the present invention as part of its internal configuration. Configuration elements in FIG. 7 identical to those in Embodiment 1 (FIG. 2) are assigned the same reference numbers as in Embodiment 1, and duplicate descriptions thereof are omitted here.

Encoding distortion (an adaptive codebook search target vector) on which perceptual weighting has been executed by perceptual weighting section 111 (FIG. 1), and a perceptual weighting section 111 synthesis filter (perceptual weighting synthesis filter) impulse response, are input to the vector quantization apparatus shown in FIG. 7.

In FIG. 7, search convolutional vector calculation section 301 comprises filtering section 302 and extraction section 303, and calculates a search convolutional vector convolutional matrix (M shown in equation 7) using a perceptual weighting synthesis filter impulse response.

Specifically, filtering section 302 of search convolutional vector calculation section 301 applies a filter to a perceptual weighting synthesis filter impulse response. To be specific, filtering section 302 convolves a FIR filter coefficient with an impulse response. Then filtering section 302 outputs a post-filtering perceptual weighting synthesis filter impulse response (first signal) to extraction section 303. Here, an example of a band-pass filter transfer function used in this embodiment is shown in equation 8. With regard to a frequency characteristic of the transfer function shown in equation 8, a characteristic (low-pass characteristic or high-pass characteristic) is weaker than the frequency characteristic shown in equation 3 of Embodiment 1 (FIG. 4).

(Equation 8)

1+0.04Z⁻¹−0.04Z⁻³ [8]

In filtering section 302, output vector components can be aggregated in low-order components by means of the high-pass characteristic of a filter by applying a filter having the transfer function shown in equation 8 to an impulse response. Thus, by implementing shortening and limitation of search convolutional vector into only a low-order part, it is possible to reduce the amount of calculation necessary for convolution of an impulse response and adaptive codebook vector.

Extraction section 303 extracts a post-filtering perceptual weighting synthesis filter impulse response (first signal) low-order part input from filtering section 302, and takes the extracted part as search convolutional vector M (also referred to as a partial signal). For example, the order of an impulse response input from perceptual weighting section 111 is made 64 (0'th to 63rd), the same as the frame order. At this time, extraction section 303 extracts 24 orders from 0'th to 23rd among impulse responses input from filtering section 302, and takes the 24 orders from 0'th to 23rd as a search convolutional vector (partial signal). Then extraction section 303 outputs the search convolutional vector (partial signal) to convolution section 203 and search section 204.

Convolution section 203 convolves a search convolutional vector (partial signal) input from extraction section 303 with respect to an entire adaptive codebook vector (adaptive codebook code vector) input from adaptive codebook 103 in accordance with equation 9 below. That is to say, convolution section 203 performs convolution using a post-filtering perceptual weighting synthesis filter impulse response low-order part extracted by extraction section 303.

(Equation 9)

y₀(n)=Σᵢ₌₀^{24 or n}u(Tₛₜₐᵣₜ+i)·M(n−i) n=0, . . . ,63 [9]

y₀(n): Synthesized initial adaptive codebook vector (synthesized vector initial vector)

u(Tₛₜₐᵣₜ+i): Adaptive codebook vector (adaptive codebook code vector)

Tₛₜₐᵣₜ: Lag (pitch delay) used initially as code vector

M(n−i): Search convolutional vector

Then convolution section 203 outputs the obtained synthesized initial adaptive codebook vector yₒ(n) (second signal) to search section 204.

Various adaptive codebook vectors are input to search section 204 from adaptive codebook 103. FIG. 8 is a block diagram showing an example of the internal configuration of search section 204 in FIG. 7. Search section 204 comprises three configuration sections—calculation section 304, comparison section 206, and update section 305—and performs adaptive codebook vector quantization (encoding) by means of three processes in these configuration sections.

Calculation section 304 of search section 204 calculates cost function Eₖ (k: adaptive codebook vector number) using a synthesized adaptive codebook vector input from convolution section 203 and a target vector input from perceptual weighting section 111. However, it is necessary to perform limitation to a case in which a target vector and synthesized vector have a positive correlation. Thus, in this embodiment, calculation section 304 calculates the numerator and denominator of cost function Eₖ using equation 7.

That is to say, search section 204 performs an adaptive codebook search using a cost function comprising a numerator represented by correlation value xtMp between an adaptive codebook vector (a plurality of code vectors) with which a post-filtering perceptual weighting synthesis filter impulse response (low-order part) has been convolved by convolution section 203 and a target vector, and a denominator represented by power ptMtMp of an adaptive codebook vector (a plurality of code vectors) with which a post-filtering perceptual weighting synthesis filter impulse response (low-order part) has been convolved by convolution section 203. Also, in the above cost function, the numerator is obtained by multiplying correlation value xtMp by absolute value |xtMp| of that correlation value, and the denominator is obtained by calculating power ptMtMp.

In this embodiment, cost function denominator sum of products calculations are punctured by calculating a cost function denominator (synthesized vector power) once every two times (that is, for every other adaptive codebook vector) in an adaptive codebook search loop. That is to say, the number of sums of products for finding the denominator is ½ that when sum of products puncturing is not performed (that is, the puncture rate is ½). Furthermore, calculation section 304 finds the cost function denominator (power) for an adaptive codebook vector for which a sum of products calculation is not performed in a cost function calculation by means of interpolation using the cost function denominator in adaptive codebook vectors before and after that adaptive codebook vector in accordance with equations 10.

[10]

$$( Equation 10 ) \\ If k is an even number or the last value in a loop \\ {U}_{k} = {\sum }_{n = 0}^{63} x ( n ) \cdot {y}_{k} ( n ) \\ {L}_{k} = 1.0 / {\sum }_{n = 0}^{63} {y}_{k} ( n ) \cdot {y}_{k} ( n ) \\ {E}_{k} = {U}_{k} \cdot \vert {U}_{k} \vert \cdot {L}_{k} \\ If k is not the first value \\ {L}_{k - 1} = ( {L}_{k - 2} + {L}_{k} ) \cdot 0.5 \\ {E}_{k - 1} = {U}_{k - 1} \cdot \vert {U}_{k - 1} \vert \cdot {L}_{k - 1} \\ If k is an odd number \\ {U}_{k} = {\sum }_{n = 0}^{63} x ( n ) \cdot {y}_{k} ( n ) \\ {U}_{k} \text{:} Cost function numerator \\ {L}_{k} \text{:} Inverse of cost function denominator \\ x ( n ) \text{:} Target vector \\ {y}_{k} ( n ) \text{:} Synthesized vector \qquad$$

As shown in equations 10, if coefficient k that is a loop counter in an adaptive codebook search loop and is synchronized with an adaptive codebook vector number and a time lag is an even number or the last value in a search loop, calculation section 304 calculates the cost function numerator and denominator. As shown in equations 10, denominator inverse Lₖ is calculated as the cost function denominator. Then, as shown in equations 10, calculation section 304 calculates cost function Eₖ using numerator Uₖ and denominator inverse Lₖ.

At this time, if coefficient k in equations 10 is not the first value, it is determined that denominator (that is, denominator inverse) Lₖ₋₁ for (k−1) preceding k has not been calculated (has been punctured). Calculation section 304 finds denominator inverse Lₖ₋₁ in (k−1) by means of interpolation using denominator inverse Lₖ₋₂ in (k−2) before and after (k−1) and denominator inverse Lₖ in k. In equations 10, denominator inverse Lₖ₋₁ is an average value of denominator inverse before and after (k−1) (that is, (k−2) and k). Thus, calculation section 304 calculates cost function Eₖ₋₁ for (k−1) using numerator Uₖ₋₁ obtained by means of a sum of products calculation and denominator (inverse) Lₖ₋₁ obtained by means of interpolation in accordance with equations 10.

If coefficient k in equations 10 is an odd number, calculation section 304 calculates and stores only cost function numerator Uₖ.

In other words, if coefficient k that is a coefficient (number) assigned respectively to an adaptive codebook vector (a plurality of code vectors) and is synchronized with a time lag is an even number or a value corresponding to the end of a search loop, search section 204 finds the denominator of a cost function in a code vector corresponding to coefficient k by means of calculation, and if coefficient k is an odd number, search section 204 finds the denominator of a cost function in a code vector corresponding to coefficient k by means of interpolation using the denominator of a cost function in a code vector corresponding to coefficient (k−1) and the denominator of a cost function in a code vector corresponding to coefficient (k+1). That is to say, within an adaptive codebook vector (a plurality of code vectors), search section 204 finds a cost function denominator by means of calculation for some code vectors, and finds a cost function denominator for code vectors other than the code vectors for which a cost function denominator is found by means of calculation by means of interpolation using the denominator calculated for the above-mentioned “some code vectors.”

A point to be noted here is that, in calculation section 304, by having cost function Eₖ denominator calculation performed for every other adaptive codebook vector (a case in which k is an even number in equations 10) the number of sum of products calculations for cost function Eₖ denominator (power) calculation is halved, and by averaging the inverse of the cost function Eₖ denominator and performing denominator interpolation, the number of times a cost function Eₖ denominator inverse is calculated is also halved. Generally (that is, when denominator puncturing is not performed), the kind of interpolation method described above is not performed for a cost function Eₖ denominator (power). However, the inventor of the present invention noted that the cost function denominator changes quite slowly as each lag proceeds in an adaptive codebook search loop, and found that it is possible to use the above-described denominator interpolation method in cost function calculation. The inventor of the present invention has confirmed that there is no particular disadvantage in using this denominator interpolation method.

Comparison section 206 of search section 204 compares cost functions Eₖ calculated successively by calculation section 304, and saves the largest value Eₖ among the calculated cost functions, and its coefficient k. Then, as a result of the adaptive codebook search, comparison section 206 takes coefficient k of the largest cost function Eₖ as optimal adaptive codebook vector number k.

Update section 305 of search section 204 updates synthesized adaptive codebook vector yₖ(n) in accordance with equations 11 below. That is to say, as shown in equations 11, update section 305 updates synthesized adaptive codebook vector yₖ(n) by calculating only difference u(−k)M(n) from synthesized adaptive codebook vector yₖ₋₁(n−1) having the preceding number (k−1). In this embodiment, since search convolutional vector M shortened from 64th-order to 24th-order is used, sum of products calculations are performed for only n=0 to 23 as shown in equations 11. Comparing this with equation 5.16.1-2 given in the VMR-WB specification (Non-Patent Literature 2), it is clear that the objects of sum of products calculation (n=0 to 23 only) have been reduced in equations 11 of the present invention.

(Equations 11)

yₖ(n)=yₖ₋₁(n−1)+u(−k)M(n) n=0, . . . ,23

yₖ(n)=yₖ₋₁(n−1) n=24, . . . ,63 [11]

In the above-described way, search section 204 finds and outputs an index (code—that is, optimal adaptive codebook vector number k).

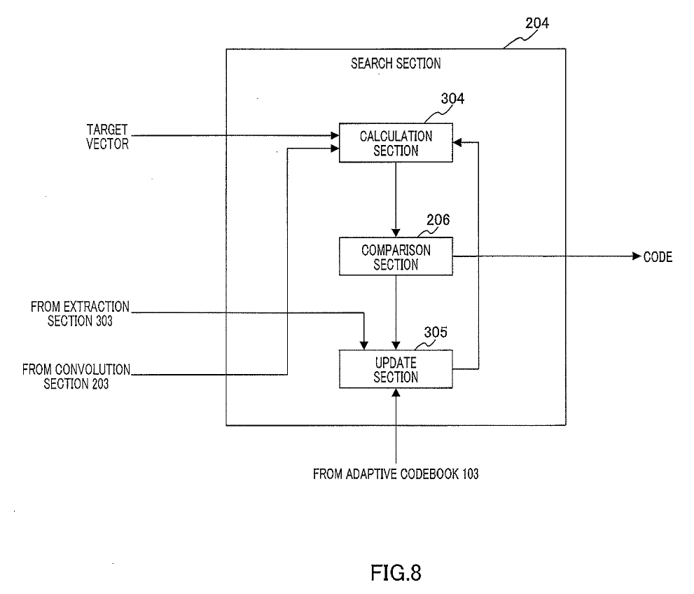

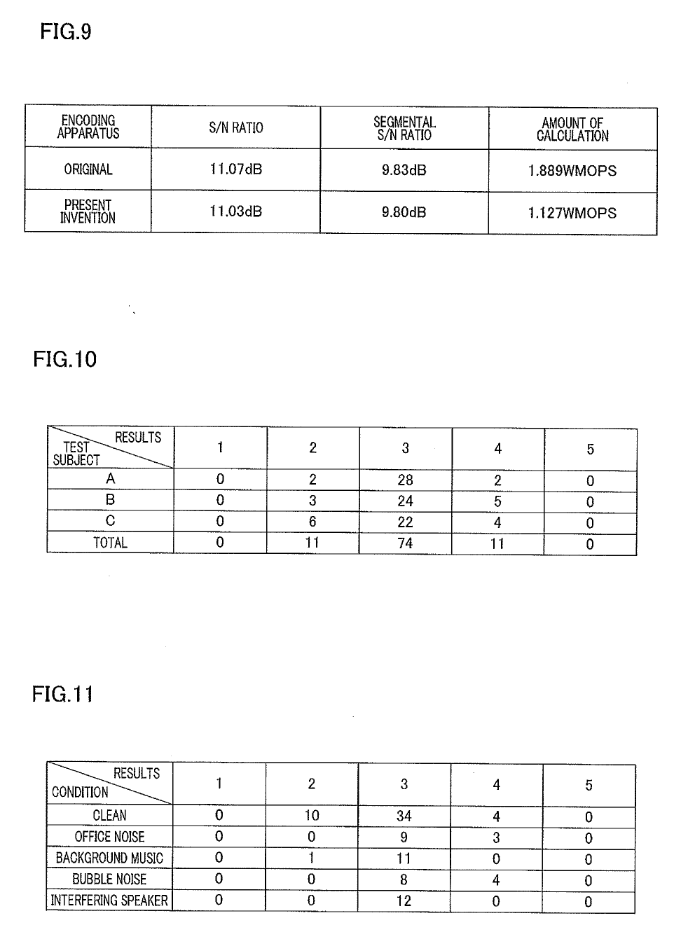

Encoding simulation results indicating the effect of the present invention are shown in FIG. 9. FIG. 9 shows an average value of 16 items of speech data with a sampling rate of 16 kHz to which various kinds of environmental noise have been added. The original (conventional-method) codec shown in FIG. 9 is an ITU-T standard G. 718 compliant floating-point simulator, with a bit rate of 8 kbps. The amount of calculation (WMOPS: Weighted Mega Operation Per Second) shown in FIG. 9 is an aggregate of operations of only a part relating to an adaptive codebook search.

As shown in FIG. 9, when an encoding apparatus according to the present invention is used, as compared with a case in which an original encoding apparatus is used there is almost no degradation of speech quality (S/N ratio and segmental S/N ratio), while the amount of calculation is greatly reduced, by approximately ⅖. That is to say, it has been verified that the amount of calculation in an adaptive codebook search can be greatly reduced, without greatly degrading speech quality, by applying filtering to an impulse response, shortening the impulse response order (using a search convolutional vector), not using a square root in a cost function in an adaptive codebook search, and puncturing cost function denominator (power) calculations in an adaptive codebook search.

Furthermore, the inventor of the present invention conducted a listening experiment to verify that speech quality degradation does not occur perceptually due to speech environmental conditions. The following five environmental conditions were used as listening experiment environmental conditions: noise-free speech data (Condition: Clean), speech data to which office noise has been added (Condition: Office noise), speech data to which music has been added in the background (Condition: Background music), speech data to which bubble noise (colored noise) has been added (Condition: Bubble noise), and speech data for which speech constituting interference has been added to the object speech data (Condition: Interfering speaker). The following 16 items of data were used as evaluation objects: eight (Condition: Clean) speech data, two (Condition: Office noise) speech data, two (Condition: Background music) speech data, two (Condition: Bubble noise) speech data, and two (Condition: Interfering speaker) speech data. The evaluation method used was a paired comparison test (a method whereby a listener listens to and compares an original and the present invention, and evaluates how much better one or the other is). There were five evaluation grades (1: Original better, 2: Original slightly better, 3: No difference, 4: Present invention slightly better, 5: Present invention better), and three test subjects (test subjects A, B, and C).

The evaluation results for test subjects A, B, and C are shown in FIG. 10. As shown in FIG. 10, very little relative superiority or inferiority is indicated overall between the original and the present invention by any of the test subjects. Also, evaluation results for each test subject categorized by environmental condition are shown in FIG. 11. As shown in FIG. 11, on an individual environmental condition basis, also, very little relative superiority or inferiority is indicated overall between the original and the present invention.

That is to say, as shown in FIG. 10 and FIG. 11, it was verified that when the present invention is used, degradation of speech quality does not occur perceptually due to speech environmental conditions in comparison with the original. That is, there was no degradation of speech quality under any of the environmental conditions, and the robustness of the present invention was verified.

As described above, according to this embodiment, as in Embodiment 1, by applying a filter having a low-pass characteristic to an impulse response, it is possible for down-sampling to be performed with almost no degradation of speech quality due to the low-pass characteristic. By this means, the amount of calculation necessary for sum of products calculations in a codebook search can be reduced.

Also, a perceptual weighting synthesis filter impulse response has large amplitude up to a high-order component due to a large low-frequency wave. As a result, by applying a filter having a high-pass characteristic to an impulse response, impulse response components can be aggregated in low-order components by means of the high-pass characteristic. Thus, according to this embodiment, the amount of calculation necessary for convolution of an impulse response and adaptive codebook vector can be reduced by extracting only a low-order part of an impulse response.

Also, according to this embodiment, denominator (power) calculations for a cost function used in a codebook search are punctured, and a punctured denominator value is interpolated using denominators calculated before and after. By this means, the amount of denominator calculation can be reduced without degrading the precision of a cost function used in a codebook search.

Moreover, according to this embodiment, a square root (special function) is not used in a cost function (equation 7) used in a codebook search. By this means, calculation necessary for special function calculation can be eliminated, and the amount of calculation necessary for a codebook search can be reduced.

That is to say, the above four reductions in amounts of calculation enable the amount of speech codec calculation to be greatly reduced. Thus, according to this embodiment, the amount of speech codec calculation can be reduced to a greater extent than in Embodiment 1 with almost no degradation of speech quality.

In this embodiment, a case has been described in which the frame order is 64, the search convolutional vector length is 24, and the sum of products calculation puncture rate is ½. However, these figures are only examples, and the present invention can also be applied to any other kinds of specifications.

In this embodiment, a case has been described in which a band-pass filter with weaker characteristics (low-pass characteristic and high-pass characteristic) than in Embodiment 1 is used, but a low-pass filter and high-pass filter may be used in combination instead of a band-pass filter. Also, in this embodiment, the band-pass filter order has been assumed to be 3 as shown in equation 8, but the present invention is not limited to this, and another band-pass filter order may also be used.

This concludes a description of embodiments of the present invention.

In the above embodiments, a CELP adaptive codebook search has been described as an example, but the present invention is not limited to CELP, and may be applied to any spectrum quantization method that uses vector quantization. For example, the present invention may also be applied to a spectrum quantization method using an MDCT (Modified Discrete Cosine Transform) or QMF (Quadrature Mirror Filter). Also, applying the present invention to an algorithm that searches for similar spectrum shapes among low-frequency domain spectra in band enhancement technology enables application to a reduction in the amount of calculation of that algorithm.

It is also possible to apply a vector quantization apparatus according to an above embodiment, or a speech encoding apparatus that includes such a vector quantization apparatus, to a base station apparatus or a terminal apparatus.

In the above embodiments, a case has been described by way of example in which the present invention is configured as hardware, but the present invention is not limited to this, and can also be implemented by software. For example, the same kind of functions as those of a vector quantization apparatus or speech encoding apparatus according to the present invention can be realized by writing an algorithm according to the present invention in a programming language, storing this program in memory, and having it executed by an information processing means.

The function blocks of the above embodiments are typically implemented as LSIs, which are integrated circuits. These may be implemented individually as single chips, or a single chip may incorporate some or all of them. Here, the term LSI has been used, but the terms IC, system LSI, super LSI, ultra LSI, and so forth may also be used according to differences in the degree of integration.

The method of implementing integrated circuitry is not limited to LSI, and implementation by means of dedicated circuitry or a general-purpose processor may also be used. An FPGA (Field Programmable Gate Array) for which programming is possible after LSI fabrication, or a reconfigurable processor allowing reconfiguration of circuit cell connections and settings within an LSI, may also be used.

In the event of the introduction of an integrated circuit implementation technology whereby LSI is replaced by a different technology as an advance in, or derivation from, semiconductor technology, integration of the function blocks may of course be performed using that technology. The application of biotechnology or the like is also a possibility.

The disclosures of Japanese Patent Application No. 2009-241616, filed on Oct. 20, 2009, and Japanese Patent Application No. 2010-112374, filed on May 14, 2010, including the specifications, drawings and abstracts, are incorporated herein by reference in their entirety.

### INDUSTRIAL APPLICABILITY

A vector quantization apparatus and vector quantization method according to the present invention are particularly suitable for a speech codec that uses CELP.

### REFERENCE SIGNS LIST

100 CELP encoding apparatus
101 LPC analysis section
102 LPC quantization section
103 Adaptive codebook
104 Fixed codebook
105 Gain codebook
106, 107 multiplier
108, 110 adder
109 LPC synthesis filter
111 Perceptual weighting section
112 Distortion minimization section
201, 302 Filtering section
202 Shortening section
203 Convolution section
204 Search section
205, 304 Calculation section
206 Comparison section
207, 305 Update section
301 Search convolutional vector calculation section
303 Extraction section

1. A vector quantization apparatus that performs a search of a codebook composed of a plurality of code vectors, to obtain a code indicating a code vector for which encoding distortion is minimal, the vector quantization apparatus comprising:
a filtering section that inputs an impulse response of a perceptual weighting synthesis filter, and applies a filter having a low-pass characteristic or a high-pass characteristic or both to the impulse response, to generate a first signal;
a convolution section that convolves the first signal with each of the plurality of code vectors to generate a second signal; and
a search section that performs the search using the second signal and a target vector.

2. The vector quantization apparatus according to claim 1, further comprising a shortening section that shortens an order of the first signal to generate a shortened signal, wherein the convolution section inputs the shortened signal instead of the first signal, and generates the second signal using the shortened signal in convolution.

3. The vector quantization apparatus according to claim 1, wherein the search section punctures elements of the second signal and elements of the target vector and performs the search.

4. The vector quantization apparatus according to claim 1, wherein the filtering section applies the filter to the impulse response in the search of an adaptive codebook according to CELP.

5. The vector quantization apparatus according to claim 1, further comprising an extraction section that extracts a low-order part of the first signal to generate a partial signal, wherein the convolution section inputs the partial signal instead of the first signal, and generates the second signal using the partial signal in convolution.

6. The vector quantization apparatus according to claim 5, wherein:
the search section performs the search using a function composed of a numerator represented by a correlation value between the second signal and the target vector, and a denominator represented by a power of the second signal; and
in the function, the numerator is obtained by multiplication of the correlation value by an absolute value of the correlation value, and the denominator is obtained by calculation of the power.

7. The vector quantization apparatus according to claim 6, wherein the search section finds the denominator for some code vectors among the plurality of code vectors by means of calculation, and finds the denominator for code vectors other than the “some code vectors” by means of interpolation using the denominator calculated for the “some code vectors.”

8. The vector quantization apparatus according to claim 6, wherein the search section, if coefficient k that is a coefficient assigned to the plurality of code vectors and is synchronized with a time lag is an even number or a value corresponding to an end of the search, finds the denominator in a code vector corresponding to the coefficient k by means of calculation, and if coefficient k is an odd number, finds the denominator in a code vector corresponding to the coefficient k by means of interpolation using the denominator in a code vector corresponding to coefficient (k−1) and the denominator in a code vector corresponding to coefficient (k+1).

9. A speech encoding apparatus comprising the vector quantization apparatus according to claim 1.

10. A communication terminal apparatus comprising the speech encoding apparatus according to claim 9.

11. A base station apparatus comprising the speech encoding apparatus according to claim 9.

12. A vector quantization method that performs a search of a codebook composed of a plurality of code vectors, to obtain a code indicating a code vector for which encoding distortion is minimal, the vector quantization method comprising:
a filtering step of applying a filter having a low-pass characteristic or a high-pass characteristic or both to an impulse response of a perceptual weighting synthesis filter to generate a first signal;
a convolution step of convolving the first signal with each of the plurality of code vectors to generate a second signal; and
a search step of performing the search using the second signal and a target vector.
